(19) United States
(12) Patent Application Publication
(10) Pub. No.: US 2007/0257108 A1
(43) Pub. Date: Nov. 8, 2007

(54) Transaction processing system and method

(76) Inventors: Victor Peter Bellino, West Chester, OH (US); Alexis Guffroy, Paris (FR)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/416,662

(22) Filed: May 3, 2006

(51) Int. Cl. G06K 15/00; G06Q 20/00

(52) U.S. Cl. 235/383; 705/23

(57) ABSTRACT

A transaction processing system and method provide a product designated transaction processing facility enable for processing purchase transaction associated with at least one designated product. The product designated facility may be a product dedicated checkout lane. The product designated facility may be a point-of-display transaction processing facility.

### FIELD OF THE INVENTION

This patent relates to transaction processing and in particular to retail transaction processing coupled with a purchase incentive.

### BACKGROUND OF THE INVENTION

Manufacturers, distributor and/or retailers employ all manner of promotions and incentives to encourage consumers to purchase a particular product or service. Most typically, the incentive represents a discount in the price of the product or service. Other incentives combine products or services to provide apparent value to the consumer if purchased together. In essence, however, this also is a form of price incentive in that the combination purchase will typically reflect a lower transaction cost than if the products and services were purchased separately. Customer service based incentives such as after purchase delivery, installation, service or repair are also popular. These also really only represent a price discount in that the consumer is getting a service at no or reduced cost in association with the product purchase.

Retailers such as grocery stores in particular may offer a customer a service based incentive to shop in particular stores. The so-called “express lane” concept, for example, allows a consumer purchasing some number or less of products to checkout at a dedicated point-of-sale terminal. The idea is that the customer will be able to checkout more quickly than if the regular checkout lanes were used. However, the “express lane” is not always express, and depending on the number of customers buying a small number of items on the given day it can be slower than regular checkout lanes.

Self-checkout systems are also employed by retailers and are billed to customers as a faster way to complete their transactions. However, self-checkout systems are generally installed for the benefit of the retailer in that they allow the retailer to have a single clerk monitor several checkout lanes where it once required one clerk per lane. An ancillary benefit to the customer is that more checkout lanes may be available at any given time, but a customer may still have to wait in line at the self-checkout lane and the transaction may not actually be faster particularly if the customer is unfamiliar with the self-checkout operation or if they require assistance from the clerk who now must service multiple checkout lanes.

Often a need arises that causes a customer to make a trip to the store to purchase a single item. This is frequently true, for example, for parents of newborns. Statistics show that parents of newborns will make at least one trip to the store on an “emergency” basis only to purchase diapers. The consumer at this point is frequently more concerned with saving time than with saving money or getting some other incentive. Express lanes and self-checkout systems, however, do not provide sufficiently fast transaction processing for these hurried customers.

### BRIEF DESCRIPTION OF THE DRAWINGS

FIG. 1 is a graphic depiction of product designated checkout lane within a retail environment.

FIG. 2 is a graphic depiction of a plurality of store shelves and aisles configured to provide product or product group designated point-of-display checkout.

FIG. 3 is a graphic depiction of a product display including point-of-display checkout processing.

FIG. 4 is a block diagram of a transaction processing facility.

FIG. 5 is a graphic depiction of another variation of a designated checkout lane within a retail environment.

FIGS. 6-8. are examples of various signs or markers which may be used to communicate product designations to consumers within a retail environment.

### DETAILED DESCRIPTION OF THE INVENTION

While retail customers typically want to save transaction costs, in many instances the speed of the transaction is most critical to the customer. A product that may be acquired quickly, particularly in a rush situation, may be more desirable to the consumer than a product for which the customer will have to wait to complete the purchase, even for a short period of time. Thus, a transaction processing system and method offers to customers a product-specific ability to complete transactions quickly. In one embodiment, the customer seeking to purchase a particular product may bypass regular point-of-sale processing lanes and instead use a product-designated point-of-sale processing lane. In another embodiment, the customer may bypass completely the point-of-sale processing lanes and conclude the transaction at or nearby the point-of-display of eligible, designated products.

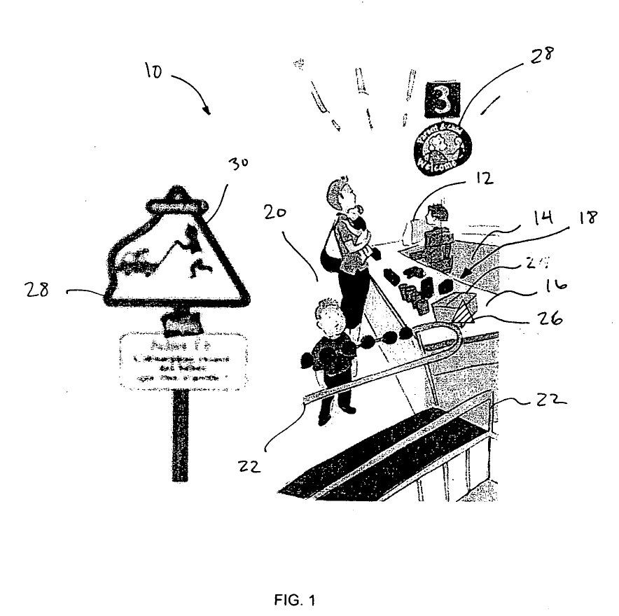

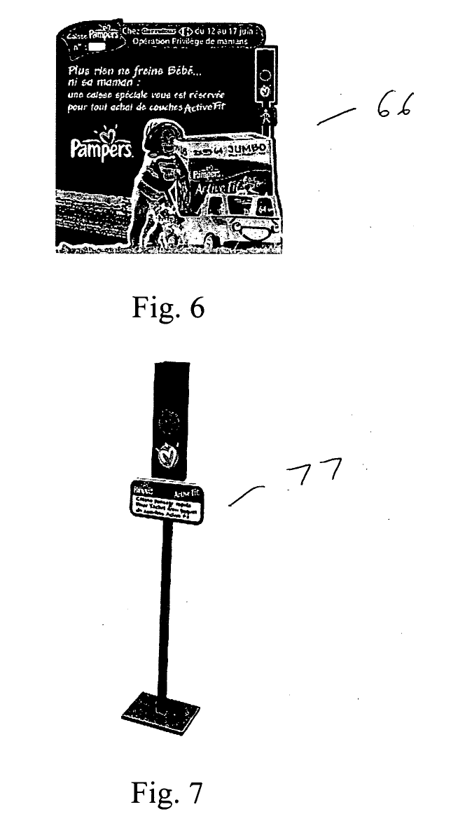

FIG. 1 illustrates a product-designated transaction processing facility 10 or as also referred to herein a checkout lane 10. The checkout lane 10 is typical of most retail establishment checkout lanes and includes a point-of-sale terminal 12, a clerk workspace 14, and a service counter 16 for supporting one or more items 18 for purchase, a customer space 20 and guiding structures 22 or other traffic management devices for guiding the customer to the checkout lane 10. The specific physical arrangement of the checkout lane 10, however, can vary based upon the retail establishment and the types of products sold. The checkout lane 10 also can accommodate product moving/conveying equipment. Furthermore, the checkout lane 10 may be a self-serve checkout facility, as discussed herein. FIG. 5 shows another arrangement of a product-designated transaction processing facility 10 or checkout lane having similar features as FIG. 1

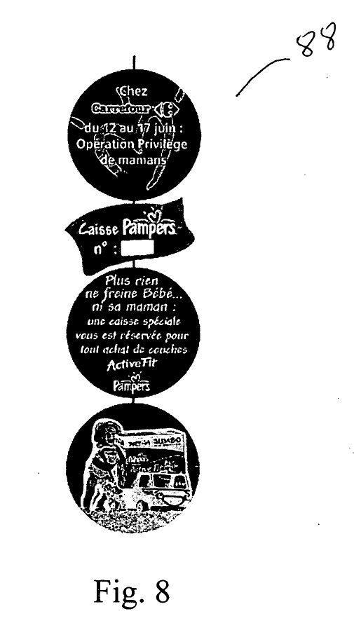

The checkout lane 10 is a product-designated checkout lane. That is, the checkout lane is reserved for use by customers purchasing one or more designated products with in the retail facility. As shown in FIGS. 1 and 5, a product 24 may include indicia 26 that identifies the product as a designated product. The customer purchasing a designated product is therefore allowed to conduct the purchase transaction at the product-designated checkout lane 10. Signage 28 may be placed adjacent or about the checkout lane 10 to identify the checkout lane 10 as a product-designated checkout lane. The signage 28 may include one or more individual signs that convey to the customers those specific products that allow the customer to checkout at that lane. As noted, a designated product, such as the product 24 may include indicia 26. The sign 28 may also indicate or depict generally the same indicia 30, so that the customer can compare the product indicia 26 with the sign to know that the product-designated checkout lane 10 may be used to conclude the transaction. Signage may also be placed throughout the store, and in particular at the location of the designated products to make the associative link between the designated products and the designated checkout lane 10. Overhead signage, (such as mobile 88 an example of which is shown in FIG. 8), free standing signage 77 (such as shown in FIG. 7) and product location program descriptors 66 (such as shown in FIG. 6) are all suitable for this purpose.

The point-of-sale terminal 12 may be configured to include a scanner or to accept stock keeping unit (SKU) data for the products in the store. Thus, the clerk may scan or enter the SKU data for the designated product, subsequent to which the point-of-sale terminal may become active to complete the transaction, including the scanning or price entry of any additional items the customer may wish to purchase. In this regard, purchase of a designated product acts as an authorization to use the product-designated checkout lane 10, but the transaction is not limited to just designated products. Instead, the customer may purchase any number and type of products providing at least one of the items is a designated product.

The checkout lane 10 may be configured as a self-serve checkout lane. As described above, the point-of-sale terminal 12 may be configured to scan or accept SKU data for a designated product to begin a transaction. In a self-serve application, the customer scans or enters the SKU data for the designated product to activate the point-of-sale terminal 12 and then scans or enters the SKU data for any additional products the customer is purchasing. Such lockout arrangement of the point-of-sale terminal 12, whether serviced by clerk or self-service, prevents the checkout lane 10 from being used for transactions that do not include at least one designated product.

The designated product need not be a single product or single family of products. Designated products may be products of a particular manufacturer/supplier, associated with a particular brand or related in purpose. For example, the designated product may be diapers from a particular manufacturer. Additional designated products may include related baby care products including by way of example: cleansing wipes, lotions, swabs, formula and the like offered by the manufacturer. Of course the manufacturer may offer a diverse array of products, and therefore, the products need not be related. The point-of-sale terminal 12 is capable upon receipt of the SKU data to determine the designated status of the product and to then become enable to complete the transaction. Including indicia 26 on the product informs the customer that the product is a designated product, while the signage 28 directs the customer to one or more designated product checkout lanes 10. The product designated checkout lane 10 offers the customer an ability to complete a transaction more quickly than by having to wait in general checkout lanes. The product designated checkout lane 10 and an ability to quickly conclude transactions may further provide a feeling of importance and particular care by the manufacturer or retailer for the customers, earning loyalty and repeat purchases.

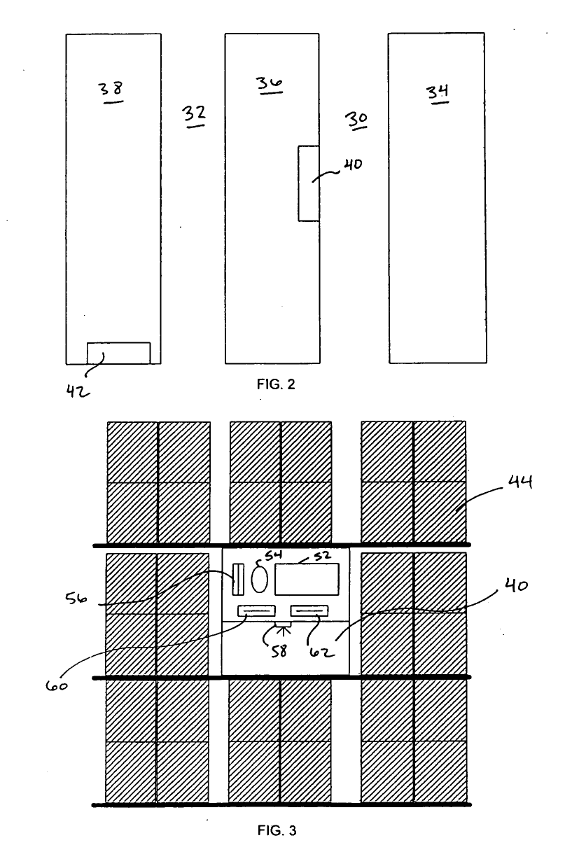

As noted, designated products may be related products, such as baby care products. Typically such related products are placed in close relationship within the aisles and shelving of a store. FIG. 2 illustrates a first aisle 30 and a second aisle 32 defined by a first product display 34, a second product display 36 and a third product display 38 of a store. The product displays may be shelving adapted to hold product or any other suitable structure for supporting and displaying a product. To facilitate transaction processing for designated products a point-of-display transaction processing facility 40 may be disposed on the shelving within an aisle, e.g., aisle 30. Alternatively, a point-of-display transaction processing facility 42 may be provided at an end cap of a product display, for example, the third product display 38. While illustrated separately, each transaction processing facility 40 and 42 may be substantially the same in structure and function.

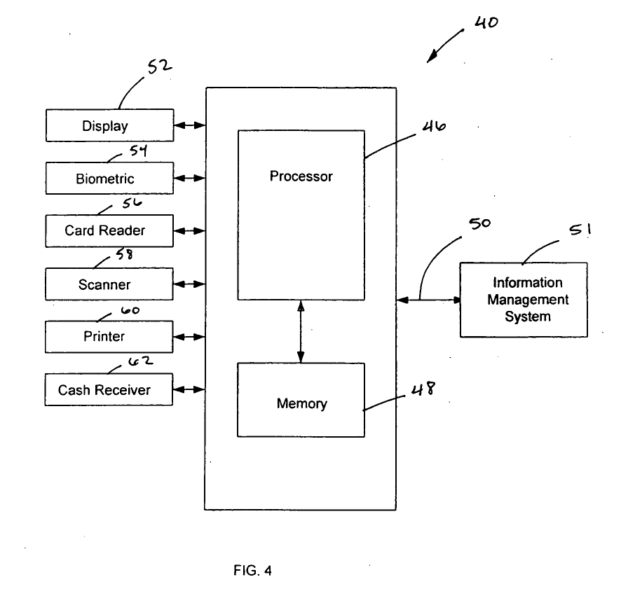

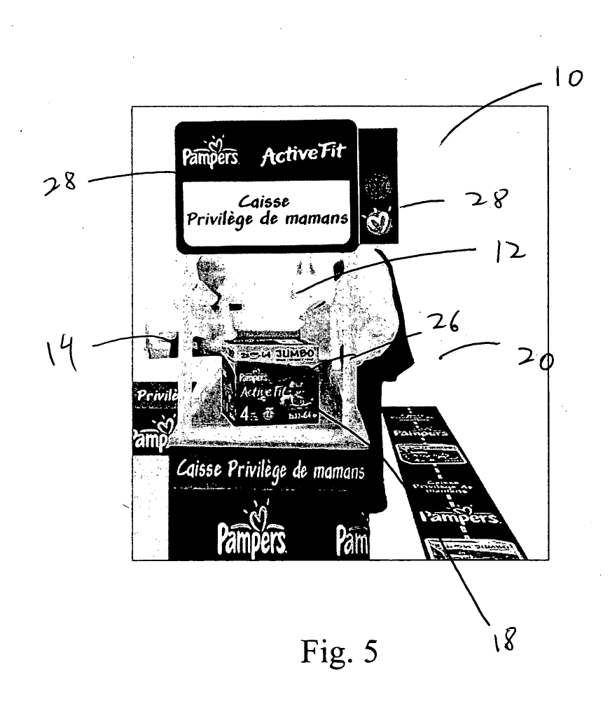

FIG. 3 is a exemplary graphic depiction of the transaction processing facility 40 disposed as part of the product display 36 and surrounded by product 44, which may be but need not be entirely designated product but which is preferably designated product. FIG. 4 is a block diagram depiction of the facility 40. The facility 40 may include a suitable power supply (not depicted) and may be coupled to a source of electrical power for powering the herein described components. The facility 40 may include a processor 46, such as a general purpose microprocessor, dedicated processor or the like coupled with a memory 48 that may contain a control program accessible by the processor for operating as herein described. The facility 40 may be coupled to communicate via communication interface 50 and a network, such as a LAN network, a wireless network, the Internet and the like, with an in-store transaction processing system and/or various other information management systems, and for example a manufacture/supplier sales/information management system, a transaction management center, and the like generally depicted generally as 51. The facility 40 may also include one or more of a display 52, a biometric scanner 54, a card reader 56, a barcode scanner 58, a printer 60 and a cash receiver/dispenser 62, each of which, if provided, is coupled to the processor 46.

The display 52 may be any suitable display used to convey operating instructions, scanned product information and the like to the consumer. The biometric scanner 54 may be a fingerprint scanner, facial recognition scanner or other type of biometric scanner used to identify the customer. Alternatively, the customer may have a customer identification card, such as a frequent shopper card or designated customer card. Scanning the card using the card reader 56 identifies the customer to the facility 40, and via the communication connection, identifies the customer to the in-store information management system, the manufacturer/supplier sales management system and/or other communicatively coupled systems. The card reader 56 may further be used to read credit/debit card data. The bar-code scanner 58 is used to scan product barcodes to obtain SKU data, although a keypad or other means of direct SKU information input may be provided. The printer 60 may print a transaction record. Additionally, the printer 60 may print a purchase confirmation label or labels that may be placed on purchased products indicating that the customer has paid for the product at that point-of-display transaction processing facility 40. The purchase confirmation labels may be brightly colored and distinctive to be readily spotted by store security or other loss prevention systems. If radio-frequency identification (RFID) technology is used for loss prevention, the scanner 58 and or another component of the facility 40 may be operable to disable an RFID tag or tags so that the customer may leave the store directly after concluding the transaction.

A customer may purchase designated products and other products at the point-of-display using either the facilities 40 and 42. The customer may first provide biometric data or scan an ID card to identify themselves to the facility 40. It may be necessary to have the customer previously register with the facility 40, in-store information management system, manufacturer/supplier information management system, or the like, so that the facility 40 or one or more of the in-store or manufacture/supplier information management system retain identification information about the customer for conducting transactions. This information may include an on-file credit/debit card number, direct account debit or any other suitable method for settling the transaction. However, prior registration is not necessary, as will be explained. Additionally, any of the above described mechanisms can be used to identify the customer to the manufacturer and/or a manufacturer sponsored loyalty program.

Once identified to the facility 40, the facility 40 may become enabled to allow the customer to scan product SKU data to conduct transactions. However, as described above in connection with the checkout lane 10, the facility 40 may be arranged such that at least one designated product be scanned or entered before the facility 40 becomes enable. Upon the facility 40 being enabled, the customer can scan or enter the SKU data for the products being purchased. The transaction may be settled based upon stored customer information, obtained by first identifying the customer via a card swipe or biometric data, by scanning a credit/debit card or by providing cash, if the facility 40 is configured to accept cash and make change, i.e., includes cash receiver 62.

As the above described example system suggests, there is great flexibility in how a customer may interact with the facility 40 to complete a transaction. Importantly, the customer may complete the transaction at the point-of-display and then exit the store directly. For example, the customer may pre-register and include information for settling the transaction, e.g., including an on-file credit/debit card, direct account debit, in-store account or other information. The manufacturer/supplier might even settle the transaction on behalf of the store as the transaction data can be communicated to the manufacturer/supplier via the communication link. The manufacturer/supplier then settles with the retail facility.

Customer preregistration is not required to conduct and settle transactions, although provide such capability further saves time. Instead, the facility 40 may be enabled simply by scanning or entering data for a designated product. The customer may then enter data for additional products to be purchased. To settle the transaction, the customer can swipe a credit/debit card or provide cash, if provided.

As with the product 24 which may include indicia 26, the products 44 may similarly include indicia to identify that these products are available for point-of-display transaction processing. Suitable signage (not depicted) in additional to information provided via the display 52 may provide instructions to the customer on use of the facilities 40 and 42.

An optional feature of methods and system described herein may include linking them to manufacturer or brand sponsored loyalty programs. For example, manufacturers of baby products such as diapers typically desire to have consumers register for loyalty programs and to provide information such as number of children they have, ages, product preferences and the like. This information can be used to provide such consumers with tailored information about new product offerings, product changes, parenting information of interest, etc. Such loyalty programs often offer discounted or free product as incentives for participation. The methods and systems described can offer shopping and purchase time savings as incentives for participating in such loyalty programs and for providing information to the program. Additionally, systems of the present invention may be provided with the functionally to collect automatically information regarding products purchased (such as size, quantity, frequency, etc.). Such collection of information is typically done with the consumers prior consent, and the time-based incentives described herein may be valuable consideration to consumers for providing such consent.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A method of processing a retail purchase transaction:
identifying a product as a designated product;
providing a transaction processing facility and associating the transaction processing facility with the designated product;
determining that a proposed retail purchase transaction includes at least one designated product;
completing the retail transaction

2. The method of claim 1, wherein providing a transaction processing facility comprises designating a transaction processing facility of a plurality of transaction processing facilities for exclusive use in processing transactions including at least one designated product.

3. The method of claim 1, wherein providing a transaction processing facility comprises providing a product transaction processing facility substantially co-located with a point-of-display of the at least one designated product.

4. The method of claim 1, comprising receiving customer data, the customer data being used in completing the retail transaction.

5. The method of claim 4, wherein receiving customer data comprises receiving biometric data from the customer.

6. The method of claim 4, wherein receiving customer date comprises receiving the customer data as scanned data from a customer identification card.

7. The method of claim 1, comprising providing indicia on designated products, the indicia identifying the products as designated products.

8. The method of claim 1, providing signage associated with the transaction processing facility, the signage identifying the transaction processing facility as a transaction processing facility for exclusive use in processing transactions including at least one designated product.

9. The method of claim 1, comprising providing indicia on designated products, the indicia identifying the products as designated products and providing signage associated with the transaction processing facility, the signage including the indicia thereby identifying the transaction processing facility as a transaction processing facility for exclusive use in processing transactions including at least one designated product.

10. The method of claim 1, wherein settling the transaction comprises communicating transaction data to a manufacturer/supplier information management system and settling the transaction via the manufacturer/supplier information management system.

11. A transaction processing system comprising:
a transaction processing facility, the transaction processing facility operable to accept product data from products to be purchased;
the transaction processing facility including a lockout functionality, the lockout functionality inhibiting operation of the transaction processing facility for completing a transaction absent entry of product data from at least one designated product; and
the lockout functionality enabling operation of the transaction processing facility for completing a transaction subsequent to entry of product data from at least one designated product.

12. The system of claim 11, the transaction processing facility being a designated checkout lane of a plurality of checkout lanes within a retail establishment.

13. The system of claim 11, the transaction processing facility being substantially co-located with a point-of-display of a designated product.

14. The system of claim 11 including a biometric data sensor to accept identifying biometric data from a customer.

15. The system of claim 11 including a card reader, the card reader operable to receive customer data via a customer identification cared or credit/debit card data via a credit/debit card.

16. The system of claim 11, the transaction processing facility being coupled to an in-store information management system or a manufacturer/supplier information management system.

17. The system of claim 11, the system comprising a printer for printing a purchase verification label to be adhered to the purchased products.
